(19) United States
(12) Patent Application Publication
(10) Pub. No.: US 2011/0182698 A1
(43) Pub. Date: Jul. 28, 2011

(54) SYSTEMS AND METHODS FOR OFFSHORE NATURAL GAS PRODUCTION, TRANSPORTATION AND DISTRIBUTION

(75) Inventors: Kok Seng Foo, Singapore (SG); Hee Yan Yip, Singapore (SG); Wen Sin Chong, Singapore (SG); Yun Shui Chen, Singapore (SG)

(73) Assignee: Keppel Offshore & Marine Technology Centre PTE LTD, Singapore (SG)

(21) Appl. No.: 13/122,114

(22) PCT Filed: Oct. 9, 2009
(86) PCT No.: PCT/SG09/00370

§ 371 Date: Mar. 31, 2011

Related U.S. Application Data
(60) Provisional application No. 61/104,059, filed on Oct. 9, 2008.

(51) Int. Cl. B63B 27/00; F17C 5/02; F25J 1/00; B65G 67/60

(52) U.S. Cl. 414/137.5; 414/803

(57) ABSTRACT

Methods and systems disclosed provide a cost efficient supply chain for natural gas, thereby enabling monetization of smaller natural gas sources and supply of natural gas to regions with low demand. The method comprises transferring a hydrocarbon fluid to a production location, liquefying the hydrocarbon fluid, storing the hydrocarbon fluid in a plurality of transferable containers, moving the plurality of transferable containers having the hydrocarbon fluid from the production location to a marine vessel, transporting the plurality of transferable containers having the hydrocarbon fluid on the marine vessel, and offloading the hydrocarbon fluid at an import location. At the import location, the transferable containers may be moved from the marine vessel to the import location and distributed at least one vehicle from the import terminal to one or more user locations for vaporizing the liquefied fluid at the user location(s).

### BACKGROUND

1. Technical Field

Embodiments of the invention relate generally to systems and methods for producing, transporting and distributing to a marketplace and/or users of natural gas which could be produced from an offshore location.

2. Description of Related Art

In recent years, natural gas has been widely used because of its low cost, clean burning and environmentally friendly qualities. Many sources of natural gas are located in offshore areas, which are not conveniently accessible to any marketplace for the natural gas. Although undersea pipelines may be built to transport the natural gas to the marketplace, large capital investments are required. Alternatively, natural gas may be processed into liquefied natural gas (LNG) at a nearby onshore location which is transported in purpose-built LNG Carriers to receiving LNG terminals before the LNG is re-gasified and then distributed to the marketplace by land pipelines. This method also requires large capital investments to build LNG terminals and distribution pipelines.

With the high infrastructure costs of transporting and distributing natural gas to a marketplace, exploitation of smaller-scale natural gas resources may be less commercially viable. For example, at associated gas fields where crude oil production is the main interest, associated natural gas is flared or re-injected with no monetizing values. High distribution costs of natural gas by pipeline infrastructures would also discourage scattered coastal communities with lower demand from being supplied with natural gas.

U.S. Patent Application Publication No. 2008/0127673 A1 (Bowen et al.) discloses a vessel for transporting liquefied natural gas. The vessel generally includes a gas transfer system for on-loading and off-loading natural gas to and from the vessel at essentially ambient temperature. The vessel further includes a gas processing facility for selectively providing liquefaction and regasification of the natural gas. The vessel also includes a containment structure for containing the liquefied natural gas during transport. The vessel may be a marine vessel or a barge vessel for transporting LNG over water, or a trailer vessel for transporting LNG over the road. A method for transporting LNG is also provided, that provides on-loading of natural gas onto a vessel, condensing the natural gas, storing the gas on the vessel in liquefied form, transporting the gas to an import terminal, vaporizing the gas, and off-loading the gas at the users or marketplace.

U.S. Patent Application Publication No. 2006/0156744 A1 (Cusiter et al.) discloses an offshore liquefied natural gas floating storage regasification unit that may receive, store, and process liquefied natural gas from carriers. A floating storage regasification unit may include transfer equipment to offload liquefied natural gas from a carrier, a first mooring system to provide for mooring of a floating storage regasification unit at a location in a body of water, a second mooring system to provide for mooring a carrier to the floating storage regasification unit, and combinations thereof. A portion of the floating storage regasification unit may be composed of a double-hull containment structure.

International Application Publication No. WO 2008/033183 A2 (ExxonMobil Upstream Research Company) is directed to methods and systems for transporting or importing LNG via vessels. Under the present techniques, SRTs, which are equipped with regasification equipment, LNG offloading equipment (e.g. marinized mechanical loading arms), LNG storage tanks, and equipment to transfer natural gas to an import terminal are utilized as temporary interchangeable FSRUs (TIFs). Two or more TIFs in conjunction with transport vessels (e.g. LNGCs) are utilized to transfer LNG between an export terminal and an import terminal. A first of the TIFs is utilized at an import terminal to offload LNG from LNGCs, while the second of the TIFs is utilized as a LNGC, carrying LNG between the export terminal and import terminal. The first of the TIFs may be replaced by the second of the TIFs to maintain operations for the import terminal. The use of multiple TIFs in combination with LNGCs provides an alternative LNG delivery approach in comparison to having a permanently moored FSRU located at the import terminal or using a fleet of SRT vessels to transport LNG between an export terminal and an import terminal.

The above-identified publications require an onshore distribution infrastructure or pipelines to distribute the natural gas to the users. Hence, problems associated with high infrastructure and distribution costs, and accessibility to low demand locations remain unresolved.

Additional information relating to LNG production, liquefaction, transportation and/or regasification technology can be found in U.S. Patent Application Publication No. 2002/0174662 A1 (Frimm et al.), U.S. Pat. No. 7,318,319 B2 (Hubbard et al.), U.S. Pat. No. 6,085,528 (Woodall et al.), International Patent Application Publication No. WO 2006/088371 A1 (STATOIL ASA), and U.S. Pat. No. 5,025,860 (Mandrin).

### SUMMARY

As will be appreciated from the present disclosure, transportation and distribution of a hydrocarbon fluid using transferable containers having the hydrocarbon fluid provides a cost-effective solution for monetizing smaller natural gas reserves and expanding consumer base to low demand remote locations. Further, it is to be appreciated that embodiments of the invention solve the above problems as well as other problems not mentioned above, such as but not limited to, reducing offshore natural gas flaring and monetizing stranded natural gas reserves.

According to one embodiment of the invention, a method for offshore hydrocarbon fluid production, transportation and distribution comprises transferring a hydrocarbon fluid to a production location, liquefying the hydrocarbon fluid, storing the hydrocarbon fluid in transferable containers, moving or transferring the transferable containers having the hydrocarbon fluid from the production location to a marine vessel, transporting the transferable the hydrocarbon fluid at an import location.

Several methods are available for offloading the hydrocarbon fluid at the import location. In one aspect, the transferable containers having the hydrocarbon fluid may be offloaded from the marine vessel by a container transfer system or other suitable lifting systems, and thereafter distributed by at least one vehicle from the import location to one or more user locations. Depending on the state of the hydrocarbon fluid stored in the transferable containers, the hydrocarbon fluid may then be vaporized at the user location(s).

According to another embodiment of the invention, a system for offshore hydrocarbon fluid production, transportation and distribution comprises: a production location for receiving and processing a hydrocarbon fluid, a loading station provided at the production location for storing the hydrocarbon fluid into transferable containers, a transportation chain which includes a marine vessel for transporting the transferable containers having the hydrocarbon fluid from the production location to an import location, and a container transfer system for moving or transferring the transferable containers containing the hydrocarbon fluid from the production location to the marine vessel. At the import location, the transferable containers may be moved from the marine vessel to the import location and distributed by at least a vehicle to one or more user location(s). Depending on the state of the hydrocarbon fluid stored in the transferable containers, the hydrocarbon fluid may then be vaporized at the user location(s). Alternatively, the hydrocarbon fluid in the transferable containers may be transferred to a pipeline to be distributed to the user location(s).

With embodiments of the invention, offshore small-scale natural gas production (e.g. below one million tones per annum of LNG production capacity or feed natural gas of below 150 million standard cubic feet per day of gas), transportation and distribution of the natural gas to a marketplace and/or users is possible in a more efficient and lower overall cost manner. This may be achieved by containerizing the storage, transportation and distribution of LNG and other gas products in transferable containers as described in the present disclosure. The same transferable containers are in a form that is ready to be distributed to the remote locations. With the cost reductions, small-scale offshore natural gas sources including associated and non-associated gas fields, which otherwise have less commercial viability, may now be exploited at significantly improved margins; communities with insufficient demand to justify expensive pipeline distribution network, e.g. coastal communities, smaller natural gas demand regions, may now be supplied with natural gas. Containerized natural gas distributed directly to end users by-passing terminal and pipeline operation will have better unit price, as an alternative to other sources of energy, such as liquid fuels.

### BRIEF DESCRIPTION OF THE DRAWINGS

Embodiments of the invention are disclosed hereinafter with reference to the drawings, in which:

FIGS. 1A and 1B illustrate a system and method for offshore natural gas production, transportation and distribution according to one embodiment of the invention;

FIGS. 2A and 2B illustrate a system and method for offshore natural gas production, transportation and distribution according to one embodiment of the invention;

FIGS. 3A and 3B illustrate a system and method for offshore natural gas production, transportation and distribution according to one embodiment of the invention;

FIGS. 4A and 4B illustrate a system and method for offshore natural gas production, transportation and distribution according to one embodiment of the invention;

FIG. 5 illustrates a method for offshore natural gas production, transportation and distribution according to one embodiment of the invention; and

FIG. 6 illustrates an example layout of a Floating Production, Storage and Offloading (FPSO) vessel.

### DETAILED DESCRIPTION

In the following description, numerous specific details are set forth in order to provide a thorough understanding of various illustrative embodiments of the invention. It will be understood, however, to one skilled in the art, that embodiments of the invention may be practiced without some or all of these specific details. In other instances, well known process operations have not been described in detail in order not to unnecessarily obscure pertinent aspects of embodiments being described. In the drawings, like reference numerals refer to same or similar functionalities or features throughout the several views.

In the present disclosure, reference is primarily made to natural gas and liquefied natural gas (LNG) for illustrative purposes. However, it is to be appreciated that embodiments of the invention may be applicable to other hydrocarbon fluids, e.g. liquefied petroleum gas (LPG), condensate, with suitable modifications.

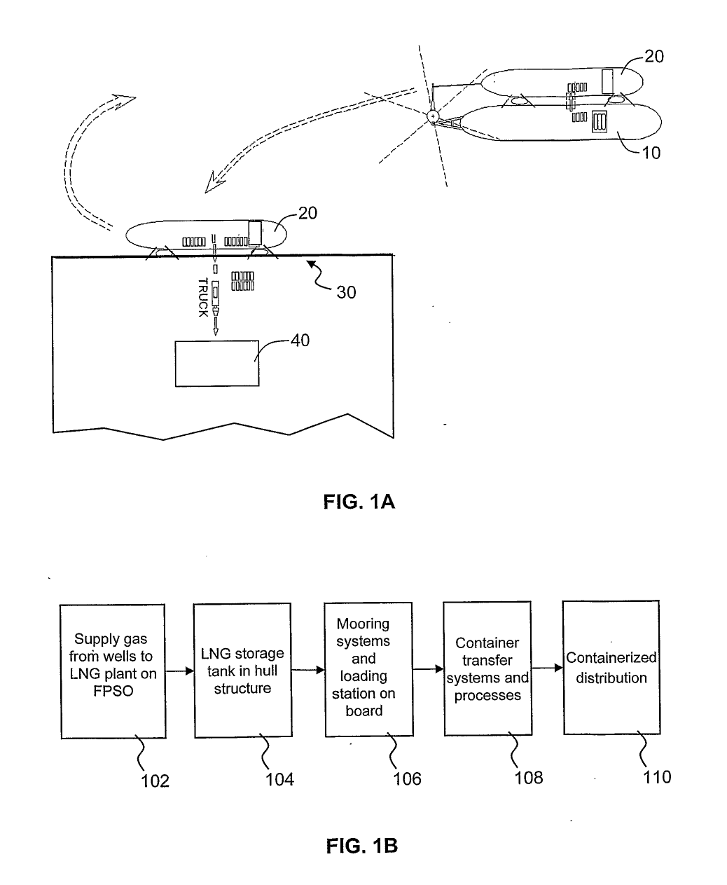

Reference is now made to FIGS. 1A and 1B illustrating a system and method for offshore natural gas production, transportation and distribution according to one embodiment of the invention. In an exemplary flowchart of FIG. 1B, various operations may be performed to transfer hydrocarbon fluids including, but not limited to, natural gas, from an export location to an import location. The transfer operations include the use of a production location or a suitable marine vessel for receiving natural gas, a gas processing plant for processing and liquefying the natural gas, a containment structure for housing tanks to store the natural gas in gaseous or liquid form, a mooring system for mooring a marine vessel 20 at the production location, a loading system for storing a liquefied fluid into transferable containers, a container transfer system for moving the transferable containers having the liquefied fluid between the production location and the marine vessel 20, and vice versa, and a transportation chain which includes offshore and/or onshore transportation.

The flowchart of FIG. 1B begins with receiving natural gas at a production location by supplying natural gas from an export location, e.g. an oil well, to a gas processing plant at the production location (block 102). Examples of the production location includes, but are not limited to, a floating production vessel (e.g. Floating Production, Storage and Offloading (FPSO) vessel, a floating LNG production vessel (FLNG), a Floating Liquefied Associated Gas (FLAG) and an offshore platform. In the present disclosure, reference is made to a FPSO 10 as a production location for illustrative purposes only. Other suitable production locations may be applicable to embodiments of the invention with suitable modifications.

More particularly, at block 102, natural gas or associated gas, procured from an offshore source or offshore well may be transferred or on-loaded onto the FPSO 10 through a gas transfer system, e.g. riser, hose or pipeline, in a gaseous phase. Other raw fluids from the well may also be transferred to the FPSO 10. The natural gas may then be supplied to a gas processing plant which may allow topside processing, including gas sweetening, dehydration and liquefaction. At the gas processing plant, the natural gas is cooled from its ambient temperature to an appropriate lower temperature where the natural gas is converted into a substantially liquefied phase, i.e. LNG. Processing of the natural gas may also result in the production of other non-LNG products, e.g. Liquefied Petroleum Gas (LPG), condensate, etc.

The various LNG and possible non-LNG products may be stored in the storage tanks in a hull of the FPSO 10 (block 104). The hull of the FPSO 10 may be a newly-constructed hull or a converted hull from an existing vessel, e.g. from oil tanker vessel. Independent insulated tanks may be provided in the hull for separately storing the LNG and non-LNG products. Various ways may be envisaged for the arrangement of tanks and conversion of hull structure from existing vessels. Further, the LNG and non-LNG products may be stored at ambient or pressured conditions.

Subsequently, mooring systems and processes may be utilized to moor a marine vessel 20 in proximity to the production location (block 106). Various mooring systems and processes may be envisaged. More particularly, the marine vessel 20 may be spaced apart from the production location over a water body.

Upon mooring the marine vessel 20, empty, partially filled or unfilled (hereinafter “at least partially unfilled”) transferable containers may be moved from the marine vessel 20 to the FPSO 10 using a suitable container transfer system. More particularly, the at least partially unfilled containers, e.g. International Standard Organization (ISO) tank containers or other suitable standard or non-standard types of containers, may be transferred to a loading station onboard the FPSO 10 and cooled to a suitable temperature. At the loading station, LNG that was stored in the containment structure of the FPSO 10 may be loaded into the at least partially unfilled transferable containers to be stored therein. When the at least partially unfilled transferable containers are suitably filled with LNG, the transferable containers filled with LNG (hereinafter referred to as “LNG transferable containers”) are subsequently moved from the FPSO 10 to the marine vessel 20 using a suitable container transfer system (block 108). Various container transfer systems and processes may be envisaged for moving the at least partially unfilled containers from marine vessel 20 to the FPSO 10, and transferring the filled LNG transferable containers from the FPSO 10 to the marine vessel 20. Examples of suitable container transfer systems include, but are not limited to, a crane transfer system, a bottom supported conveyor transfer system, self-adjustable transfer arms system, and any suitable lifting systems.

After the LNG transferable containers are moved to or loaded onto the marine vessel 20, the marine vessel 20 is operable to transport the LNG transferable containers from the production location to an import location 30, e.g. a port or a LNG terminal, which may be at an onshore location. When the marine vessel 20 reaches the import location 30, the LNG transferable containers may be moved from the marine vessel 20 to the import location 30 using a suitable container transfer system such as but not limited to the above-mentioned and other possible systems. The offloaded LNG transferable containers may then be distributed to one or more user locations, using one or more vehicles, by a rail infrastructure, e.g. trains, a road infrastructure, e.g. trucks, and/or by a water way, e.g. smaller marine vessels (block 110). More particularly, the unloading of the LNG from the marine vessel 20 to the import location 30, and distribution of the LNG from the import location 30 to a user location 40 may be in a containerized form. The LNG in the LNG transferable containers remains unprocessed or liquefied at the point of offloading from the carrier marine vessel 20 and loading onto at least one vehicle which is to transport the LNG transferable containers to one or more user locations. Upon arrival of the LNG transferable containers at the user location 40, e.g. power plant, industrial user, the LNG from the LNG transferable containers may then be vaporized or re-gasified by heating the LNG from a liquefied phase to a gaseous phase. Accordingly, a gas processing plant, evaporator or other suitable vaporization methods and systems may be provided at the user location 40 for vaporizing the LNG. The natural gas in the gaseous phase is then supplied at the user location 40 for consumption.

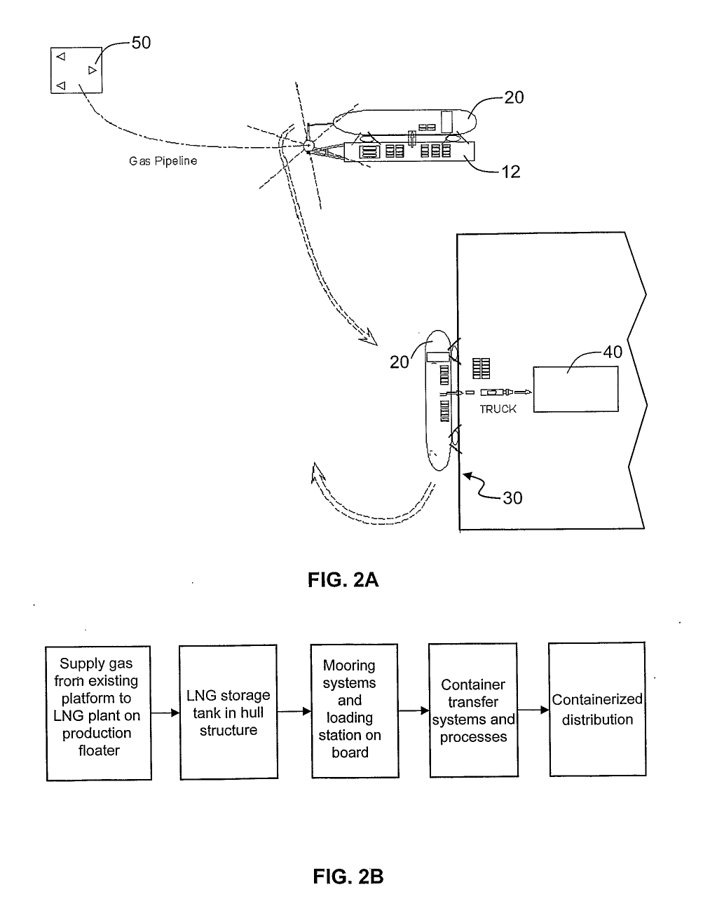

FIGS. 2A-2B, 3A-3B, 4A-4B illustrate certain modifications and variations to FIGS. 1A-1B according to other embodiments of the invention. It is to be appreciated that various aspects of the embodiments of FIGS. 2A-2B, 3A-3B, 4A-4B are largely similar to the embodiment of FIGS. 1A-1B with certain differences described in the following paragraphs.

In the embodiment of FIGS. 2A-2B, associated gas is supplied from an existing offshore platform 50 to a LNG production floater 12 by gas pipeline. The existing offshore platform 50 may be primarily for production of crude oil. The LNG production floater 12 includes at least a gas processing plant, a mooring system, a loading station and a container transfer system. Similar to the embodiment of FIGS. 1A-1B, the associated gas is processed into LNG and possibly other non-LNG products, the LNG is stored into at least partially unfilled transferable containers, the transferable containers filled with LNG are moved from the LNG production floater 12 onto a marine vessel 20 for transporting to an import location 30. At the import location 30, the LNG transferable containers may be offloaded from the marine vessel 20 and distributed to one or more user locations 40 in a containerized form. Upon arrival at a user location 40, the LNG from the containers may then be vaporized into a gaseous phase for user consumption. This embodiment may be useful for existing offshore platforms which lack space for a gas processing plant.

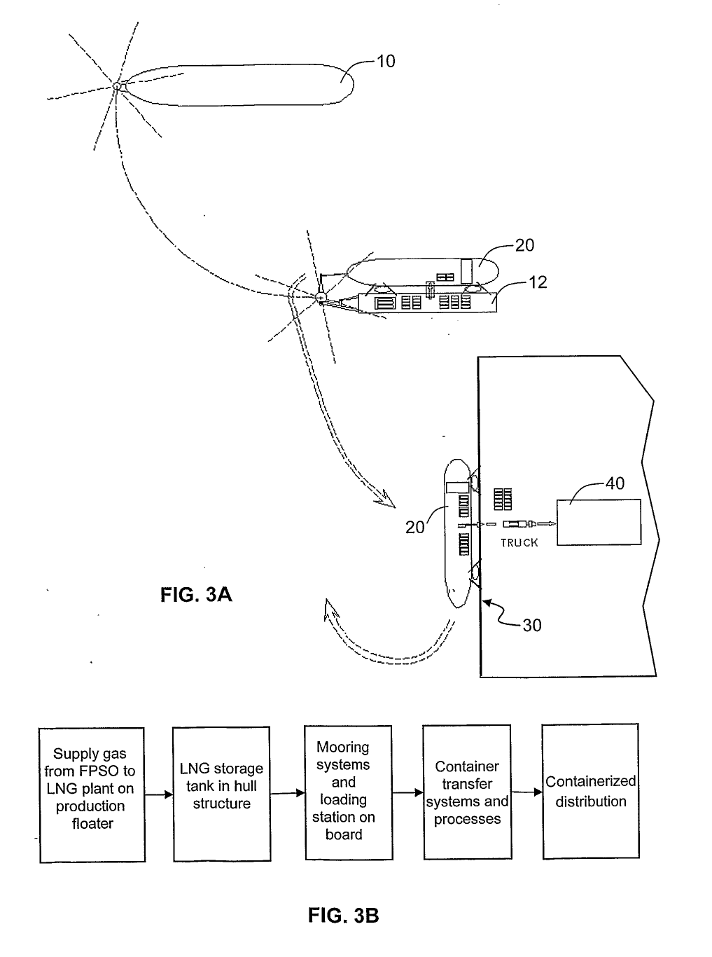

In the embodiment of FIGS. 3A-3B, associated gas is supplied from a FPSO 10 to a LNG production floater 12 by a gas pipeline. The LNG production floater 12 includes at least a gas processing plant, a mooring system, a loading station and a container transfer system. Similar to the embodiment of FIGS. 1A-1B, the associated gas is processed into LNG⁻ and possibly other non-LNG products, the LNG is stored into at least partially unfilled transferable containers, the transferable containers filled with LNG are moved onto a marine vessel 20 for transporting to an import location. At the import location, the LNG transferable containers may be offloaded from the marine vessel 20 and distributed to one or more user locations 40 in a containerized form. Upon arrival at the user location 40, the LNG from the containers may then be re-gasified into a gaseous phase for user consumption. This embodiment may be useful if existing FPSOs lack space for a gas processing plant.

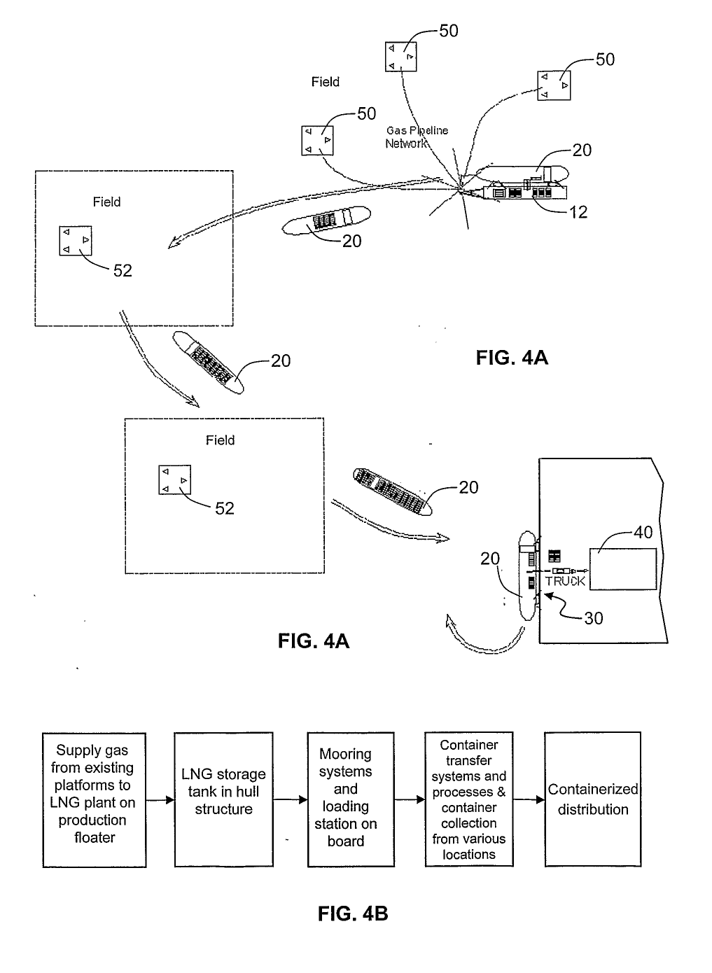

In the embodiment of FIGS. 4A-4B, associated gas is supplied from one or more existing offshore platforms 50 to a LNG production floater 12 by a gas transfer system, e.g. a network of gas pipelines, hoses or risers. The LNG production floater 12 includes at least a gas processing plant, a mooring system, a loading station and a container transfer system. Similar to the embodiment of FIGS. 1A-1B, the associated gas is processed into LNG and possibly other non-LNG products, the LNG is stored into at least partially unfilled transferable containers, the transferable containers filled with LNG are moved onto a marine vessel 20 for transporting to an import location 30. At the import location 30, the LNG transferable containers may be offloaded from the marine vessel 20 and distributed to one or more user locations in a containerized form. Upon arrival at a user location 40, the LNG from the LNG transferable containers may then be vaporized into a gaseous phase for user consumption. In addition to production of LNG on the first plurality of existing offshore platforms 50, LNG may also be produced using LNG skids located on at least a second existing platform 52. The LNG is loaded into containers which are stored at the second platform 52 while awaiting to be transported to an import location 30. A marine vessel 20 may move between the LNG production floater 12 and second platform 52 to receive LNG transferable containers therefrom before delivering the LNG transferable containers to an import location 30. At the marine vessel 20 and/or the second platforms 52, container transfer systems may be provided for moving the LNG transferable containers to and from the marine vessel 20.

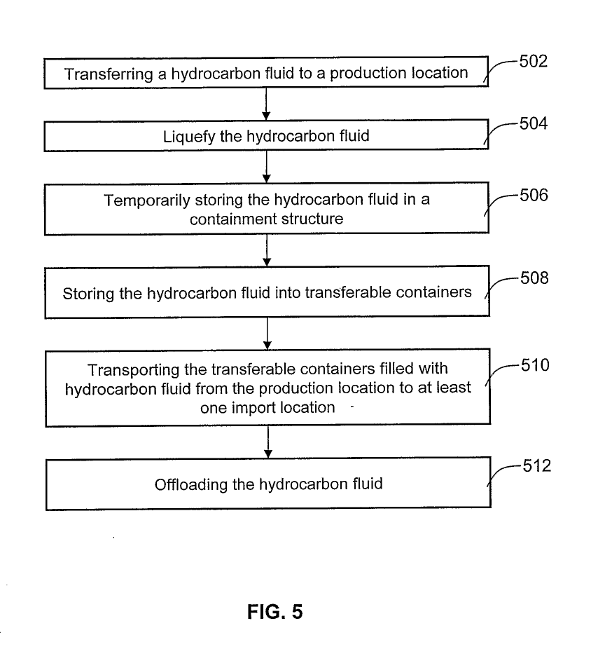

FIG. 5 shows a flow chart describing a method for offshore natural gas production, transportation and distribution according to one embodiment of the invention. The method begins with transferring a hydrocarbon fluid to a production location (block 502). It is to be appreciated from the foregoing that the hydrocarbon fluid may be an associated gas or non-associated gas. The method may then proceed to process the hydrocarbon fluid, such as to liquefy the hydrocarbon fluid (block 504). It is to be appreciated that processing or liquefying the hydrocarbon fluid may be optional depending on whether a liquefied or gaseous fluid is to be subsequently stored and transported in transferable containers. The hydrocarbon fluid, in liquefied or gaseous form, may be temporarily stored in a containment structure at the production location (block 506). Alternatively, the hydrocarbon fluid may be directly loaded into transferable containers without temporary storage. The method then proceeds to store the hydrocarbon fluid into transferable containers (block 508). Storage of the hydrocarbon fluid in the transferable containers may be in liquefied or gaseous form, at ambient or cryogenic temperature, at ambient or pressured condition, and maintained at these conditions throughout transportation of the transferable containers from the production location to an import location or a user location. In order to store the hydrocarbon fluid into transferable containers, at least partially unfilled transferable containers may be moved from a marine vessel to the production location to be loaded with the hydrocarbon fluid before the transferable containers filled with hydrocarbon fluid is moved or transferred from the production location to the marine vessel. The marine vessel may then transport the transferable containers filled with hydrocarbon fluid from the production location to at least one import location (block 510). The marine vessel may also collect other transferable containers filled with hydrocarbon fluid from other production locations before proceeding to the at least one import location.

At an import location, the hydrocarbon fluid may be offloaded (block 512). The import location may be onshore or offshore, at a specialized LNG terminal or non-specialized port. Offloading of the hydrocarbon fluid at the import location may be carried out in several ways. For example, the transferable containers having the hydrocarbon fluid may be moved or transferred from the marine vessel onto the import location by a container transfer system or other suitable lifting system, and thereafter distributed by at least one vehicle from the import location to at least one user location by rail infrastructure, road infrastructure and/or water way. At the user location, the hydrocarbon fluid, if in liquefied form, may be vaporized. In another example, re-gasification facilities may be provided at the import location; accordingly, the transferable containers may be moved or transferred from the marine vessel to the import location before being re-gasified. In yet another example, the hydrocarbon fluid may be transferred from the transferable containers to a pipeline to be distributed to at least one user location.

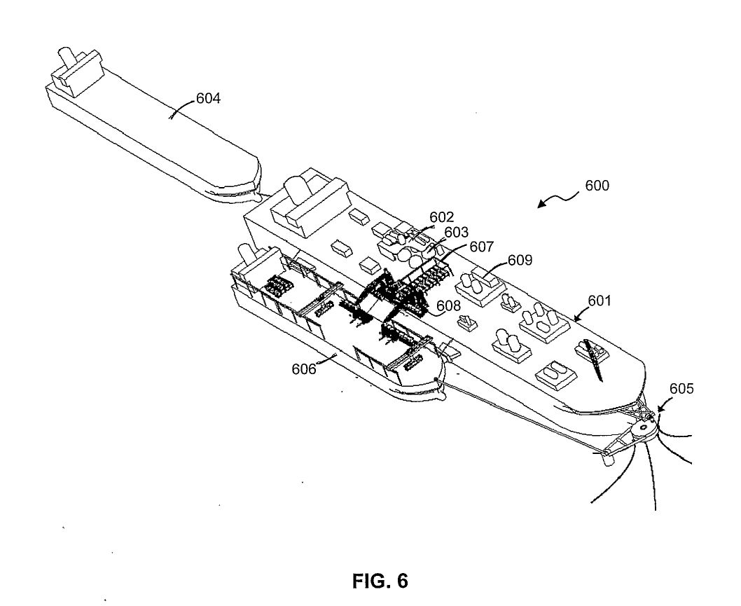

FIG. 6 illustrates an example layout of a Floating Production, Storage and Offloading (FPSO 10) vessel 600 that may be used in embodiments of the invention. The FPSO 600 includes a gas processing plant or LNG topside processing plant 609, a containment structure or hull structure 601, a storage hold 602, a container transfer system 608, and a mooring system 605. Other process equipment and living quarters may also be provided on the FPSO 600. FIG. 6 further illustrates possible arrangements of marine vessel 604 and shuttle tanker 606 relative to the FPSO 600.

The gas processing plant 609 is operable to process associated gas into LNG and possibly various other non-LNG products. Associated gas may be supplied to the gas processing plant 609 by a gas transfer system (not shown), e.g. hoses, risers, pipelines, which connects an associated gas source to the gas processing plant 609. At the gas processing plant, the associated gas is processed and cooled to produce a liquefied natural gas (LNG) and possibly other liquefied products (non-LNG products).

The LNG and any non-LNG products may be transferred into a storage hold 602 for storage. More particularly, the storage hold 602 provides several independent insulated tanks 603 arranged in the hull structure 601 of the FPSO 600. The LNG and any non-LNG products may be stored separately in the independent tanks 603. The hull structure 601 may be newly-constructed or converted from existing vessels. Various hull conversion layouts may be used in embodiments of the invention.

A loading station 607 may be provided to transfer LNG from the independent tanks 603 into at least partially unfilled transferable containers, e.g. ISO tank containers. The at least partially unfilled transferable containers may be moved from a carrier marine vessel 606 onto the FPSO 600 to be loaded with LNG.

Thereafter, the transferable containers filled with LNG, i.e. LNG transferable containers, are transferred back to the marine vessel 608 which will then transport the LNG transferable containers to an import location 30 or to other locations, e.g. existing offshore platforms, to receive more LNG transferable containers before proceeding to an import location 30.

A mooring system 605 is provided to allow side-by-side mooring of a marine vessel 606 to the FPSO 600 for transfer of containers in both directions therebetween. Various mooring systems and operations may be employed. The mooring system 605 may minimize relative motions of the marine vessel 606 and the FPSO 600 during container transfer operations, and reduce forces in mooring lines and fenders. Alternatively, suitable mooring systems may be provided to allow a tandem mooring arrangement of the marine vessel 606 with the FPSO 600.

A container transfer system 608 may also be suitably arranged on the FPSO 600 for moving or transferring transferable containers between the FPSO 600 and a marine vessel 606, and vice versa, when the marine vessel 606 is suitably moored, e.g. in a side-by-side or a tandem arrangement. Examples of suitable container transfer systems include, but are not limited to, crane transfer system, bottom supported conveyor transfer system, self-adjusting transfer arms system and other suitable lifting systems. Another transfer or offloading system may be suitably arranged on the FPSO 600 to transfer crude oil from the FPSO 600 to a shuttle tanker 604 which may be moored to the FPSO 600 in a tandem arrangement.

In embodiments of the invention, a transportation chain is provided which comprises at least one marine vessel 20 for receiving the LNG transferable containers from at least one production location and transporting the LNG transferable containers to at least one import location 30 which may be located onshore. The transportation chain further includes a plurality of vehicles for distributing the LNG transferable containers from the import location 30 to one or more user locations 40. To this purpose, a rail infrastructure, a road infrastructure and/or a water way may be provided at the import location 30 connecting the import location 30 to one or more user locations 40 for distributing the LNG transferable containers.

The foregoing systems and methods effectively obviate the need for a pipeline infrastructure connecting the import terminal to a user location. LNG transferable containers are transported from an export terminal at an offshore facility to an import terminal at an onshore facility using containers, and thereafter delivered directly to the consumers and/or marketplace without the need for costly pipeline infrastructure. This way, significantly lower infrastructure and distribution costs can be achieved. With the direct (or door-step) containerized distribution, it would be more commercially viable to supply consumers located in regions with low LNG demand. Since containerized distribution of LNG allows bypassing of a LNG terminal and/or pipeline infrastructure, other gas products, e.g. LPG, may also be distributed in the same manner.

The reduced transportation and distribution costs also increase the commercial viability of exploiting small scale natural gas fields, e.g. crude oil fields. At crude oil fields with small natural gas resource, natural gas is typically disposed of as flare or reinject. With embodiments of the invention, natural gas in the form of associated gas may be harvested and processed into useful products instead. At the same time, multi-products: LNG, LPG, condensate, etc. can be produced, stored and transported without incurring excessive number of transport vessels and infrastructure costs. Further, with the use of containers to store and transport LNG and other products, the need for bulk offloading using loading arm or cryogenic hoses is eliminated, thereby providing a safe and compact process.

Other embodiments will be apparent to those skilled in the art from consideration of the specification and practice of the invention. Furthermore, certain terminology has been used for the purposes of descriptive clarity, and not to limit the disclosed embodiments of the invention. The embodiments and features described above should be considered exemplary, with the invention being defined by the appended claims.

1-28. (canceled)

29. A method comprising:
processing an associated gas into a hydrocarbon fluid at an offshore location being one of a first marine vessel and a production platform, including liquefying the hydrocarbon fluid;
loading the liquefied hydrocarbon fluid into a plurality of transferable containers at the offshore location;
moving the plurality of transferable containers filled with the liquefied hydrocarbon fluid from the offshore location onto a second marine vessel;
transporting the plurality of transferable containers filled with the liquefied hydrocarbon fluid on the second marine vessel from the offshore location to an import location;
offloading the plurality of transferable containers having the liquefied hydrocarbon fluid from the second marine vessel at the import location; and
transporting the plurality of transferable containers having the liquefied hydrocarbon fluid on at least a vehicle to at least one user location for vaporization.

30. The method of claim 29, further comprising: after processing the associated gas, storing the liquefied hydrocarbon fluid in a containment structure at the offshore location, and wherein loading the liquefied hydrocarbon fluid further includes transferring the liquefied hydrocarbon fluid from the containment structure into the plurality of transferable containers.

31. The method of claim 30, further comprising: before loading the liquefied hydrocarbon fluid into the plurality of transferable containers, disposing the plurality of transferable containers at a loading station at the offshore location for transferring the hydrocarbon fluid, moving the plurality of transferable containers, which are filled with the liquefied hydrocarbon fluid, to the second marine vessel.

32. The method of claim 29, further comprising: before loading the liquefied hydrocarbon fluid, moving the plurality of transferable containers, which are unfilled, from the second marine vessel to the offshore location; and after loading the liquefied hydrocarbon fluid, moving the plurality of transferable containers, which are filled with the liquefied hydrocarbon fluid, to the second marine vessel.

33. The method of claim 32, wherein transporting the plurality of transferable containers includes collecting an other plurality of transferable containers, which are filled with liquefied hydrocarbon fluid, by the second marine vessel from at least an other offshore location.

34. The method of claim 29, wherein loading the liquefied hydrocarbon fluid further includes loading at least one of a liquefied natural gas and a liquefied petroleum gas.

35. The method of claim 34, wherein loading the liquefied hydrocarbon fluid into a plurality of transferable containers at the offshore location further includes loading the liquefied hydrocarbon fluid at one of an ambient condition and a pressured condition, and maintaining the liquefied hydrocarbon fluid at the one of the ambient condition and the pressured condition throughout transportation from the offshore location to the at least one user location.

36. The method of claim 29, wherein loading the liquefied hydrocarbon fluid further includes the plurality of containers having an International Organization for Standardization (ISO) tank container type.

37. The method of claim 29, wherein loading the liquefied hydrocarbon fluid further includes the first marine vessel being one of a Floating Production, Storage and Offloading (FPSO) vessel, a Floating Liquefied Natural Gas vessel (FLNG), and a Floating Liquefied Associated Gas (FLAG) vessel.

38. The method of claim 37, wherein the Floating Liquefied Natural Gas vessel (FLNG), and the Floating Liquefied Associated Gas (FLAG) are newly constructed or converted from an existing vessel.

39. A system comprising:
an offshore location for receiving an associated gas, the offshore location being one of a first marine vessel and a production platform, including:
a gas processing plant for processing the associated gas into a hydrocarbon fluid and liquefying the hydrocarbon fluid;
a loading station for loading the liquefied hydrocarbon fluid into a plurality of transferable containers;
a container transfer system for moving the plurality of transferable containers filled with the liquefied hydrocarbon fluid from the offshore location to a second marine vessel,
wherein the second marine vessel is operable to transport the plurality of transferable containers from the offshore location to an import location wherein the plurality of transferable containers is further transportable by at least one vehicle to at least one user location for vaporization.

40. The system of claim 39, wherein the offshore location further includes a containment structure for storing the liquefied hydrocarbon fluid before loading into the plurality of transferable containers.

41. The system of claim 40, wherein the container transfer system is further operable for moving the plurality of transferable containers, which are unfilled, from the second marine vessel to the loading station at the offshore location.

42. The system of claim 41, wherein the liquefied hydrocarbon fluid is one of a liquefied natural gas and a liquefied petroleum gas.

43. The system of claim 42, wherein the liquefied hydrocarbon fluid is stored into the plurality of transferable containers at one of an ambient condition and a pressured condition, and maintained at the one of the ambient condition and the pressured condition throughout transportation from the offshore location to the at least one user location.

44. The system of claim 39, wherein the plurality of transferable containers are of an International Organization for Standardization (ISO) tank container type.

45. The system of claim 39, wherein the first marine vessel is one of a Floating Production, Storage and Offloading (FPSO) vessel, a Floating Liquefied Natural Gas vessel (FLNG), and a Floating Liquefied Associated Gas (FLAG) vessel.

46. A method comprising:
processing an associated gas at a plurality of offshore locations being one of a first marine vessel and a production platform, including liquefying the hydrocarbon fluid;
loading the liquefied hydrocarbon fluid into a plurality of transferable containers being an International Organization for Standardization (ISO) tank container type;
moving the plurality of transferable containers filled with the liquefied hydrocarbon fluid from the plurality of offshore locations onto a second marine vessel;
collecting the plurality of transferable containers filled with the liquefied hydrocarbon fluid from the plurality of offshore locations by the second marine vessel and transporting to an import location;
offloading the plurality of transferable containers filled with the liquefied hydrocarbon fluid from the marine vessel at the import location; and
transporting the plurality of transferable containers filled with the liquefied hydrocarbon fluid on at least a vehicle to at least one user location for vaporization.

47. The method of claim 29, further comprising: before processing the associated gas, supplying the associated gas to the offshore location from a third marine vessel.

48. The system of claim 39, further comprising a third marine vessel for supplying the offshore location with the associated gas.

49. The method of claim 46, further comprising: before processing the associated gas, supplying the associated gas to the plurality of offshore locations from a third marine vessel.

50. The system of claim 39, further comprising a second offshore location, the second offshore location including a second plurality of transferable containers and a second container transfer system for moving the second plurality of transferable containers from the second offshore location to the second marine vessel.
